(19) United States
(12) Patent Application Publication
(10) Pub. No.: US 2016/0063672 A1
(43) Pub. Date: Mar. 3, 2016

(54) ELECTRONIC DEVICE AND METHOD FOR GENERATING THUMBNAIL PICTURE

(71) Applicants: Fu Tai Hua Industry (Shenzhen) Co., Ltd., Shenzhen (CN); HON HAI PRECISION INDUSTY CO., LTD., New Taipei (TW)

(72) Inventors: CHIH-SAN CHIANG, New Taipei (TW); YANG YANG, Shenzhen (CN); NIAN-LONG HUANG, Shenzhen (CN); HUA-DONG CHENG, Shenzhen (CN)

(21) Appl. No.: 14/698,196

(22) Filed: Apr. 28, 2015

(30) Foreign Application Priority Data
Aug. 29, 2014 (CN) 201410434028.6

(51) Int. Cl. G06T 3/40; G09G 5/22

(52) U.S. Cl. CPC G06T 3/40; G09G 5/227; G09G 2340/045

(57) ABSTRACT

An electronic device obtains resolutions of original pictures prestored in the electronic device. The electronic device zooms out the original pictures according to relationships between the obtained resolutions and predefined resolutions, generates thumbnails association with the original pictures according to the zoomed pictures; and displays the generated thumbnails according to a predefined order.

### CROSS-REFERENCE TO RELATED APPLICATIONS

This application claims priority to Chinese Patent Application No. 201410434028.6 filed on Aug. 29, 2014, the contents of which are incorporated by reference herein.

### FIELD

The subject matter herein generally relates to picture processing technology, and more particularly to an electronic device and a method for generating thumbnail picture.

### BACKGROUND

Electronic devices such as mobile phones, tablet computers, E-books store pictures and thumbnails associated with the pictures in a picture database. When a user browses the pictures, in fact, he sees the thumbnail pictures which are currently one size.

### BRIEF DESCRIPTION OF THE DRAWINGS

Implementations of the present technology will now be described, by way of example only, with reference to the attached figures, wherein:

FIG. 1 is a block diagram of an embodiment of an electronic device.

FIG. 2 is a block diagram of an alternative embodiment of the system for generating thumbnail picture in FIG. 1.

FIG. 3 is a flowchart of a first embodiment of a method for generating thumbnail of a picture.

FIG. 4 is a flowchart of a second embodiment of a method for generating thumbnail of a picture.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The word “module”, and “unit” as used hereinafter, refers to logic embodied in hardware or firmware, or to a collection of software instructions, written in a programming language, such as, for example, Java, C, or assembly. One or more software instructions in the modules may be embedded in firmware. It will be appreciated that modules may comprise connected logic units, such as gates and flip-flops, and may comprise programmable units, such as programmable gate arrays or processors. The modules described herein may be implemented as either software and/or hardware modules and may be stored in any type of non-transitory computer-readable storage medium or other computer storage device. The term “comprising,” when utilized, means “including, but not necessarily limited to”; it specifically indicates open-ended inclusion or membership in the so-described combination, group, series and the like.

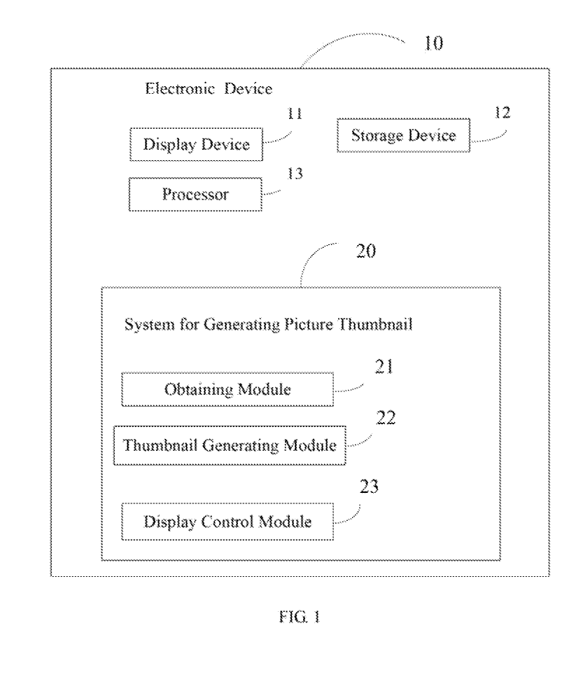

FIG. 1 shows a system 20 for generating thumbnail of a picture in accordance with an exemplary embodiment. The system 20 is installed and run in an electronic device 10.

The electronic device 10 includes, but is not limited to, a display device 11, a storage device 12, and at least one processor 13. The at least one processor 13 can be a central processing unit (CPU), a microprocessor, or other data processor chip that performs functions of the electronic device 10. The storage device 12 stores a number of original pictures. A header file of an original picture includes information of the original picture. In an embodiment, the information of the original picture includes resolution of the original picture. The resolution of a picture herein refers to the pixel values both in vertical and in horizontal, such as 640×480, 400×400. In an alternative embodiment, the information of the original picture further includes ratio of length to width. The display device 11 can be, for example a touch screen.

The system 20 includes, but is not limited to, an obtaining module 21, a thumbnail generating module 22 and a display control module 23. Modules 21-23 can comprise computerized instructions in the form of one or more computer-readable programs that can be stored in a non-transitory computer-readable medium, for example the storage device 12, and executed by the at least one processor 13 of the electronic device 10.

The obtaining module 21 can obtain information of the original pictures. In the embodiment, the obtaining module 21 obtains resolutions of the original pictures.

The thumbnail generating module 22 can zoom out the original pictures according to relationships between the resolutions obtained by the obtaining module 21 and predefined resolutions, and can generate thumbnails associated with the original pictures according to the zoomed out pictures. The display control module 23 can control the display device 11 to display the generated thumbnails according to a predefined order.

In the embodiment, when the resolutions of the original pictures obtained by the obtaining module 21 fall into a first interval, such as the obtained resolutions are smaller than a first predefined resolution, the thumbnail generating module 22 zooms out the original pictures to a first size, and the thumbnail generating module 22 further generates the thumbnails having the first size. When the resolutions of the original pictures obtained by the obtaining module 21 fall into a second interval, such as the obtained resolutions are bigger than the first predefined resolution and smaller than a second predefined resolution; the thumbnail generating module 22 zooms out the original pictures to a second size, and the thumbnail generating module 22 generates the thumbnails having the second size. When the resolutions of the original pictures obtained by the obtaining module 21 fall into a third interval, such as the obtained resolutions are bigger than the second predefined resolution; the thumbnail generating module 22 zooms out the original pictures to a third size, and the thumbnail generating module 22 generates the thumbnails having the third size.

In an alternative embodiment, the obtaining module 21 further obtains ratios of length to width of the original pictures. The thumbnail generating module 22 further zooms out the original pictures according to relationships between the obtained ratios and a number of predefined ratios and relationships between the obtained resolutions and the predefined resolutions, and generates thumbnails according to the zoomed pictures.

In the embodiment, when the ratio obtained by the obtaining module 21 equals a first predefined ratio, and the obtained resolution falls into a first interval, the thumbnail generating module 22 zooms out the original pictures to a first size and generates thumbnails of the original pictures having the first size. When the ratio obtained by the obtaining module 21 equals a second predefined ratio; and the obtained resolution falls into a second interval, the thumbnail generating module 22 zooms out the original pictures to a second size and generates thumbnails of the original pictures having the second size. When the ratio obtained by the obtaining module 21 equals a third predefined ratio, and the obtained resolution falls into a third interval, the thumbnail generating module 22 zooms out the original pictures to a third size and generates thumbnails of the original pictures having the third size. In the embodiment, the second size thumbnail is bigger than the first size thumbnail, and the third size thumbnail is bigger than the second size thumbnail. In an alternative embodiment, the second size is four times of the first size, and the third size is six times of the first size.

In the embodiment, the predefined order is priority displaying thumbnails having bigger size, for example, when there are three sizes of thumbnails, the first size is smaller than the second size, the second size is smaller than the third size, the display device 11 displays thumbnails having the third size first, then displays the thumbnails having the second size, and displays the thumbnails having the first size last.

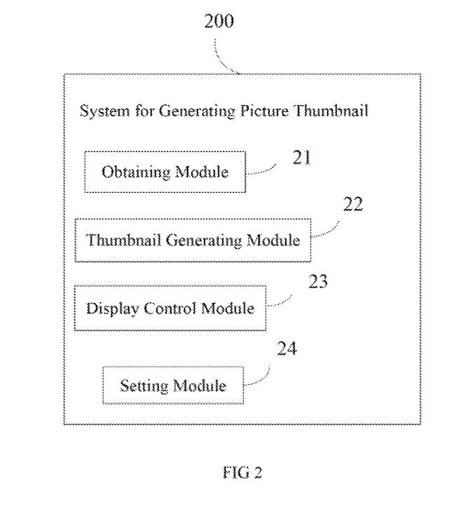

FIG. 2 illustrates a block diagram of the system 200 according to a second embodiment. The system 20′ further includes a setting module 24. The setting module 24 can generate predefined configurations for adjusting the thumbnails of the original pictures in response to input operations.

In the embodiment, the predefined configurations generated by the setting module 24 include predefined resolutions of the original pictures, predefined sizes of the thumbnails, and the relationship between the predefined resolution and the predefined size. The predefined resolutions of original pictures and the sizes of the thumbnails can be set according to need. In an alternative embodiment, the predefined configurations generated by the setting module 24 include predefined resolutions of the original pictures, predefined ratios of length to width of the original pictures, predefined sizes of the thumbnails, and the relationships between the resolutions of the original pictures, the predefined ratios of the original pictures and the predefined sizes of the thumbnails.

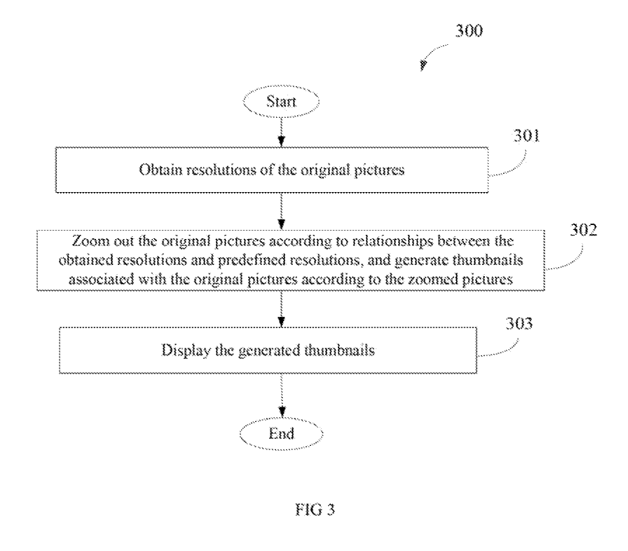

Referring to FIG. 3, a flowchart of a method for generating a thumbnail of a picture is presented in accordance with an example embodiment which is being thus illustrated. The example method 300 is provided by way of example, as there are a variety of ways to carry out the method. The method 300 described below can be carried out using the configurations illustrated in FIGS. 1 and 2, for example, and various elements of these figures are referenced in explaining example method 300. Each block shown in FIG. 3 represents one or more processes, methods or subroutines, carried out in the exemplary method 300. Additionally, the illustrated order of blocks is by example only and the order of the blocks can change according to the present disclosure. The exemplary method 300 can begin at block 301.

At block 301, the obtaining module obtains resolutions of the original pictures.

In an alternative embodiment, the obtaining module further obtains ratios of length to width of the original pictures.

At block 302, the thumbnail generating module zooms out the original pictures according to relationships between the obtained resolutions and predefined resolutions, and generates thumbnails associated with the original pictures according to the zoomed pictures.

In an alternative embodiment, the thumbnail generating module further zooms out the original pictures according to relationships between the obtained ratios of length to width and the relationships between the obtained resolutions and predefined resolutions, and generates thumbnails association with the original pictures according to the zoomed pictures.

At block 303, the display control module controls the display device to display the generated thumbnails according to a predefined order. In the embodiment, the predefined order is priority displaying of thumbnails having bigger size.

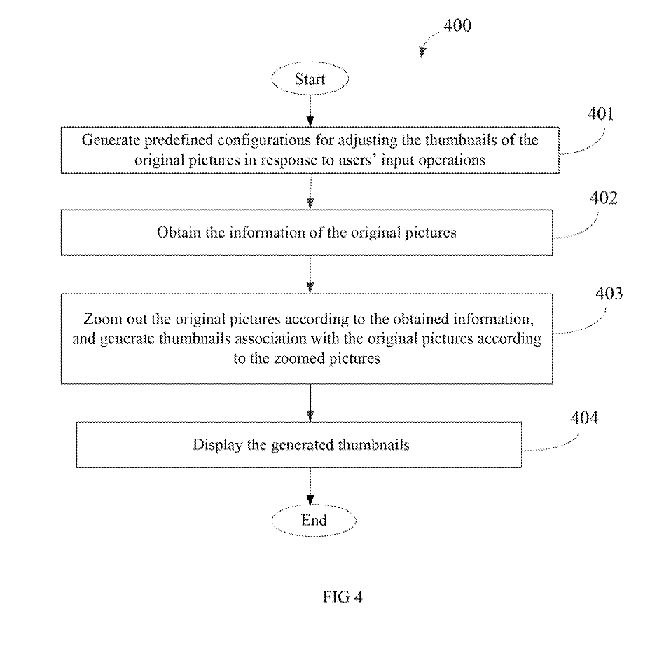

FIG. 4 illustrates a flowchart of a method for generating picture thumbnail is presented in accordance with a second embodiment which is being thus illustrated. The example method 400 is provided by way of example, as there are a variety of ways to carry out the method. The method 400 described below can be carried out using the configurations illustrated in FIGS. 1 and 2, for example, and various elements of these figures are referenced in explaining example method 400. Each block shown in FIG. 4 represents one or more processes, methods or subroutines, carried out in the exemplary method 400. Additionally, the illustrated order of blocks is by example only and the order of the blocks can change according to the present disclosure. The exemplary method 400 can begin at block 401.

At block 401, the setting module generates predefined configurations for adjusting the thumbnails of the original pictures in response to input operations.

In the embodiment, the predefined configurations include predefined resolutions of the original pictures, predefine sizes of the thumbnails, and the relationships between the predefined resolutions and the predefined sizes. In an alternative embodiment, the predefined configurations include predefined resolutions of the original pictures, predefined ratios of length to width of the original pictures, predefined sizes of the thumbnails, and the relationships between the resolutions of the original pictures, the predefined ratios of length to width of the original pictures and the predefined sizes of the thumbnails.

At block 402, the obtaining module obtains the information of the original pictures.

At block 403, the thumbnail generating module zooms out the original pictures according to the information obtained by the obtaining module and generates thumbnails associated with the original pictures according to the zoomed pictures.

At block 404, the display control module controls the display device to display the generated thumbnails according to a predefined order. In the embodiment, the predefined order is priority displaying of thumbnails having bigger size.

The embodiments shown and described above are only examples. Many details are often found in the art such as the other features of a system for generating picture thumbnail. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. An electronic device comprising:
at least one processor, and
a storage device coupled to the processor that stores one or more programs, which when executed by the processor, cause the at least one processor to:
obtain resolutions of original pictures that are prestored in the storage device;
zoom out the original pictures according to relationships between the obtained resolutions and predefined resolutions;
generate thumbnails associated with the original pictures according to the zoomed pictures; and
cause a display to display the generated thumbnails according to a predefined order.

2. The electronic device as claimed in claim 1, wherein the at least one processor further generates predefined configurations for adjusting the thumbnails of the original pictures in response to users' input operations.

3. The electronic device as claimed in claim 2, wherein the predefined configurations comprises the predefined resolutions of the original pictures, predefine sizes of the thumbnails, and relationships between the predefined resolutions and the predefined sizes.

4. The electronic device as claimed in claim 2, wherein when the resolutions of the original pictures fall into a first interval, the at least one processor zooms out the original pictures to a first size and generates the thumbnails having the first size; when the resolutions of the original pictures fall into a second interval, the at least one processor zooms out the original pictures to a second size and generates the thumbnails having the second size; when the resolutions of the original pictures fall into a third interval, the at least one processor zooms out the original pictures to a third size and generates the thumbnails having the third size.

5. The electronic device as claimed in claim 2, wherein the at least one processor further obtains ratios of length to width of the original pictures, zooms out the original pictures according to relationships between the obtained ratios and predefined ratios, and generates thumbnails according to the zoomed pictures.

6. The electronic device as claimed in claim 5, wherein when the obtained ratio of an original picture equals a first predefined ratio, the at least one processor zooms out the original picture to a first size and generates the thumbnail of the original picture having the first size; when the obtained ratio of an original picture equals a second predefined ratio, the at least one processor zooms out the original picture to a second size and generates the thumbnail of the original picture having the second size; when the obtained ratio of an original picture equals a third predefined ratio, the at least one processor zooms out the original picture to a third size and generates a thumbnail of the original picture having the third size.

7. The electronic device as claimed in claim 5, wherein the at least one processor obtains the resolutions and the ratios of length to width from the header files of the original pictures.

8. The electronic device as claimed in claim 1, wherein the resolution of a picture is pixel values of the picture in the vertical and in level.

9. A method for generating picture thumbnail using an electronic device, the electronic device storing a plurality of original pictures, the method comprising:
obtaining resolutions of the original pictures;
zooming out the pictures according to relationships between the obtained resolutions and predefined resolutions;
generating thumbnails associated with the original pictures according to the zoomed pictures; and
displaying the generated thumbnails according to a predefined order.

10. The method as claimed in claim 9, further comprising:
generating predefined configurations for adjusting the thumbnails of the original pictures in response to users' input operations.

11. The method as claimed in claim 10, wherein the predefined configurations comprise the predefined resolutions of the original pictures, predefined sizes of the thumbnails, and relationships between the predefined resolutions and the predefined sizes.

12. The method as claimed in claim 11, wherein when the resolutions of the original pictures fall into a first interval, zooming out the original pictures to a first size and generating the thumbnails having the first size; when the resolutions of the original pictures fall into a second interval, zooming out the original pictures to a second size and generating the thumbnails having the second size; when the resolutions of the original pictures fall into a third interval, zooming out the original pictures to a third size and generating the third size of the thumbnails.

13. The method as claimed in claim 11, further comprises:
obtaining ratios of length to width of the original pictures;
zooming out the original pictures according to relationships between the obtained ratios and predefined ratios; and
generating the thumbnails of the original pictures according to the zoomed pictures.

14. The method as claimed in claim 13, wherein obtaining the resolutions and ratios of length to width from the header file of the original pictures.

15. The method as claimed in claim 12, wherein the configurations comprise the predefined resolutions of the original pictures, the predefined ratios of length to width of the original pictures, predefined sizes of the thumbnails, and the relationships between the resolutions of the original pictures, the predefined ratios of the original pictures, and the predefined sizes of the thumbnails.

16. A non-transitory storage medium having stored thereon instructions that, when executed by a processor of a computing device, causes the processor to perform a method for generating picture thumbnail, the method comprising:
obtaining resolutions of original pictures;
zooming out the pictures according to relationships between the obtained resolutions and predefined resolutions;
generating thumbnails associated with the original pictures according to the zoomed pictures; and
displaying the generated thumbnails according to a predefined order.

17. The non-transitory storage medium as claimed in claim 16, further comprising: generating predefined configurations for adjusting the thumbnails of the original pictures in response to users' input operations.

18. The non-transitory storage medium as claimed in claim 17, wherein the predefined configurations comprise the predefined resolutions of the original pictures, predefined sizes of the thumbnails, and relationships between the predefined resolutions and the predefined sizes.

19. The non-transitory storage medium as claimed in claim 18, wherein when the resolutions of the original pictures fall into a first interval, zooming out the original pictures to a first size and generating the thumbnails having the first size; when the resolutions of the original pictures fall into a second interval, zooming out the original pictures to a second size and generating the thumbnails having the second size; when the resolutions of the original pictures fall into a third interval, zooming out the original pictures to a third size and generating the third size of the thumbnails.

20. The non-transitory storage medium as claimed in claim 16, further comprises:
obtaining ratios of length to width of the original pictures;
zooming out the original pictures according to relationships between the obtained ratios and predefined ratios; and
generating the thumbnails of the original pictures according to the zoomed pictures.
